(19) United States
(12) Patent Application Publication
(10) Pub. No.: US 2023/0366055 A1
(43) Pub. Date: Nov. 16, 2023

(54) METHOD FOR PREPARING BAINITE HOT-WORKING DIE

(71) Applicant: Hebei Vocational University of Industry and Technology, Shijiazhuang (CN)

(72) Inventors: Shuang LI, Shijiazhuang (CN); Zhen CAO, Shijiazhuang (CN); Zhen WANG, Shijiazhuang (CN); Long LIU, Shijiazhuang (CN); Yanlin SHI, Shijiazhuang (CN); Xiaocai YANG, Shijiazhuang (CN); Zhen YANG, Shijiazhuang (CN); Lun ZHANG, Shijiazhuang (CN); Yingli HUA, Shijiazhuang (CN); Mingmei XIA, Shijiazhuang (CN)

(21) Appl. No.: 18/226,219

(22) Filed: Jul. 25, 2023

Related U.S. Application Data
(63) Continuation-in-part of application No. PCT/CN2022/105085, filed on Jul. 12, 2022.

(30) Foreign Application Priority Data
Dec. 15, 2021 (CN) 202111536501.8

(51) Int. Cl. C21D 9/00; C22C 38/12; C22C 38/10; C22C 38/02; C22C 38/00; C22C 38/04; C22C 33/04; C21D 8/00; C21D 6/00; C21D 1/18; C21D 1/84; C23F 17/00

(52) U.S. Cl. CPC C21D 9/0068; C22C 38/12; C22C 38/10; C22C 38/02; C22C 38/005; C22C 38/002; C22C 38/04; C22C 33/04; C21D 8/005; C21D 6/005; C21D 6/007; C21D 6/008; C21D 1/18; C21D 1/84; C23F 17/00; C21D 2211/002; C23C 8/26

(57) ABSTRACT

A method for preparing a Bainite hot-working die, includes: 1) weighing and mixing alloy raw materials including: C: 0.50-0.60%, Si: 0.20-0.25%, Mn: 1.00-1.50%, W: 2.10-3.00%, Mo: 3.50-5.00%, V: 0.50-1.00%, Co: 0.60-1.10%, P≤0.02%, rare earth (RE): 0.01-0.10%, (RE)/(S)>3.0, (RE)×(S)<0.004%, the balance being Fe and impurities; smelting, casting, annealing the alloy raw materials, to yield steel billets; 2) forging the steel billets to obtain Bainite die billets; 3) mechanically roughening the Bainite die billets, to yield die inserts; 4) tempering the die inserts, to yield hardened Bainite die inserts through secondary strengthening of Bainite; 5) mechanically machining the hardened Bainite die inserts to yield precisely sized die inserts; 6) nitriding the precisely sized die inserts; and 7) assembling the die inserts to yield a Bainite hot-working die.

### CROSS-REFERENCE TO RELATED APPLICATIONS

This application is a continuation-in-part of International Patent Application No. PCT/CN2022/105085 with an international filing date of Jul. 12, 2022, designating the United States, now pending, and further claims foreign priority benefits to Chinese Patent Application No. 202111536501.8 filed Dec. 15, 2021. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, MA 02142.

### BACKGROUND

The disclosure relates to a method for preparing a Bainite hot-working die.

Conventional methods for preparing hot-working dies involve long production processes from die material manufacturing to finished dies, including: material smelting, casting, first annealing, forging, second annealing, die machining (rough machining), heat treatment, fine machining, nitriding treatment, etc. Specifically, during the preparation process of die material and die products, multiple heat treatments are required, including soft annealing after forging, quench hardening, soft tempering, surface strengthening heat treatment processes, etc. Thus, existing hot-working die manufacturing cycle is long, many heat treatment processes are involved, and it is time-consuming and energy consuming.

### SUMMARY

To solve the aforesaid problems, the objective of the disclosure is to provide a method for preparing a Bainite hot-working die, the method comprising:
1) weighing and mixing alloy raw materials comprising: C: 0.50-0.60%, Si: 0.20-0.25%, Mn: 1.00-1.50%, W: 2.10-3.00%, Mo: 3.50-5.00%, V: 0.50-1.00%, Co: 0.60-1.10%, P≤0.02%, rare earth (RE): 0.01-0.10%, (RE)/(S)>3.0, (RE)×(S)<0.004%, the balance being Fe and impurities; smelting, casting, annealing the alloy raw materials, to yield steel billets;
2) forging the steel billets to obtain Bainite die billets;
3) mechanically roughening the Bainite die billets, to yield die inserts;
4) tempering the die inserts, to yield hardened Bainite die inserts through secondary strengthening of Bainite;
5) mechanically machining the hardened Bainite die inserts to yield precisely sized die inserts;
6) nitriding the precisely sized die inserts; and
7) assembling the die inserts to yield a Bainite hot-working die.

In a class of this embodiment, in 2), the steel billets are heated to a temperature of 1050° C.-1150° C. and held for 6-10 hours; the steel billets are forged multi-directionally with a final forging temperature ≥980° C., and cooled at a rate of 0.5-3° C./s, to yield the Bainite die billets. After that, the hardness of the Bainite die billets is less than 450 Vickers-hardness 30 (HV30), which can be directly used for rough machining without extra annealing and softening treatment. The machining size allowance is retained during rough machining.

The Bainite die billets are obtained by controlling the final forging temperature ≥980° C. and the cooling rate of the forged material between 0.5-3° C./s after multi-directional forging of the die material, and its hardness is in the range of 390-450 HV30; and, due to the characteristics of the material composition, the Bainite structure can be tempered for secondary strengthening.

In a class of this embodiment, in 4), the die inserts are tempered at a temperature of 540° C.-680° C. for 2-3 times, and each tempering time lasts 2.0-6.0 hours, preferably, the die inserts are tempered two times, each lasts 2.5 hours, to produce secondary strengthening effect on the die inserts. The obtained Bainite die inserts have high hardness, toughness and good wear resistance. The hardness of the die inserts is increased to 49-51 HRC (Rockwell Hardness C), meeting the hardness requirements of the stamping die.

In a class of this embodiment, in 6), the precisely sized die inserts are nitrided at a temperature of 520° C.-600° C., to form a nitriding layer having a thickness of 110-150 and a white bright layer having a thickness of 3-8 Thus, the hardness of the surface of the die inserts has been increased to 820-920 HV_{0.3} (Vickers-hardness).

In a class of this embodiment, in 6), nitriding adopts a surface plasma nitriding process.

In a class of this embodiment, in 6), the surface plasma nitriding process is performed under the following conditions: voltage: 910-980 V; atmosphere ratio: NH₃:Ar=1:7; furnace pressure: 200-280 Pa; nitriding temperature: 520° C.-600° C.; nitriding time: 5-9 hours.

The following advantages are associated with the method for preparing a Bainite hot-working die of the disclosure:
1. The Bainite die steel of the disclosure is obtained by controlled cooling after forging, and is directly suitable for rough machining without the treatment of annealing after forging to reduce hardness. Therefore, the “annealing softening” treatment before mechanical rough machining is omitted.
2. The die steel of the disclosure can produce a strong secondary strengthening effect at the tempering temperature, thus improving the hardness and wear resistance of the die steel. That is to say, the goal of high-temperature quenching and hardening heat treatment after mechanical rough machining can be achieved simultaneously in the medium and low temperature tempering process. Therefore, the method omits the process of “high-temperature quenching and hardening heat treatment” before the tempering treatment after mechanical rough machining.
3. The method of disclosure achieves mechanical precision machining on the die inserts after one tempering to obtain the precisely sized die inserts. The second tempering is not carried out independently, and the second tempering heat treatment is combined with nitriding heat treatment, thereby omitting the energy consuming of the heat treatment process.

Although the preparation process of the disclosure omits at least three steps compared to the existing methods of hot-working die (one annealing process to reduce hardness after forging, one high-temperature quenching and hardening process, and the second tempering treatment process), the hot-working die prepared by the disclosure still has excellent performance: the hardness of 49-51 HRC (Rockwell Hardness C), the impact toughness value Ak of over 106 J, and the surface Vickers hardness of over 820 HV_{0.3} after nitriding, so the die is particularly suitable as a hot stamping die. Compared with the traditional long flow austenitic die manufacturing process, the hot-working die produced by the disclosure has the advantages of good heat conduction performance, high wear resistance, good high-temperature adhesion resistance, short manufacturing cycle of die material, short process, low energy consumption, low cost, etc.

In addition, the hot-working die prepared by the disclosure can effectively prevent surface roughening of the die, and after surface plasma nitriding, the service life of the die can be greatly extended. After the die is worn out, it can be put back into reuse after repair and plasma nitriding, greatly improving the total service life of the hot-working die.

### BRIEF DESCRIPTION OF THE DRAWINGS

FIG. 1 is a flow chart of a method for preparing a Bainite hot-working die according to one example of the disclosure;

FIG. 2 is a SEM diagram of the forged Bainite die steel in Example 1 of the disclosure;

FIG. 3 is a continuous cooling transformation (CCT) curve of the forged Bainite die steel in Example 1 of the disclosure;

FIG. 4 is a TEM diagram of Bainite die steel obtained after rough machining and tempering for secondary strengthening in Example 1 of the disclosure;

FIG. 5 is a metallographic diagram of the material structure of the die inserts after surface plasma nitriding treatment in Example 1 of the disclosure; and

FIG. 6 is a flow chart of a method for preparing an Austenitic hot-working die in the related art.

### DETAILED DESCRIPTION

To further illustrate the disclosure, embodiments detailing a method for preparing a Bainite hot-working die are described below. It should be noted that the following embodiments are intended to describe and not to limit the disclosure.

The Bainite hot-working die of the disclosure comprises C: 0.50-0.60%, Si: 0.20-0.25%, Mn: 1.00-1.50%, W: 2.10-3.00%, Mo: 3.50-5.00%, V: 0.50-1.00%, Co: 0.60-1.10%, P≤0.02%, rare earth (RE): 0.01-0.10%, (RE)/(S)>3.0, (RE)×(S)<0.004%, and the balance is Fe and impurities.

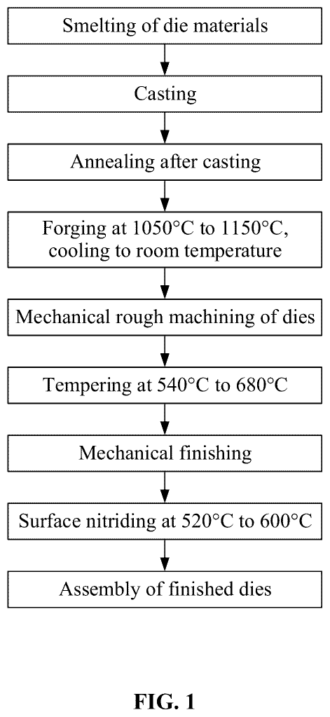

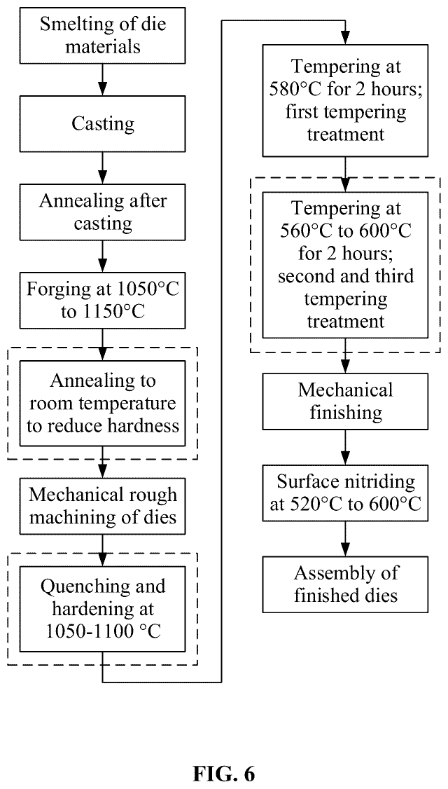

As shown in FIG. 1, the flow chart of the method for preparing a Bainite hot-working die comprises: smelting of die materials→casting to yield billets→annealing after casting→forging→mechanical rough machining of dies→first tempering treatment→mechanical finishing→surface nitriding treatment→assembly of finished dies. Compared with FIG. 6, the dashed box in FIG. 6 is an omitted process of the present disclosure compared to the prior art.

Specifically, according to the composition proportion of the die steel, the method for preparing the Bainite hot-working die of the disclosure is as follows:
1) weighing and mixing alloy raw materials according to the above composition proportion, and smelting, casting, annealing the alloy raw materials, to yield steel billets; the above treatments are routine operations in the art;
2) forging the steel billets to obtain Bainite die billets; specifically, the steel billets are heated to a temperature of 1050° C.-1150° C. and held for 6-10 hours; the steel billets are forged multi-directionally with a final forging temperature ≥980° C., and cooled at a rate of 0.5-3° C./s, to yield the Bainite die billets; after that, the hardness of the Bainite die billets is 390-450 HV30, which can be directly used for rough machining without extra annealing and softening treatment. At the same time, due to the characteristics of the material composition, the Bainite structure can be tempered for secondary strengthening;
3) mechanically roughening the Bainite die billets, to yield die inserts; the machining size allowance is retained during rough machining;
4) tempering the die inserts, to yield hardened Bainite die inserts through secondary strengthening of Bainite; the die inserts are tempered at a temperature of 540° C.-680° C. for 2-3 times, and each tempering time lasts 2.0-6.0 hours, to produce secondary strengthening effect on the die inserts; the Bainite die inserts with high hardness, toughness and wear resistance are obtained; the hardness of the die inserts is increased to 49-51 HRC (Rockwell Hardness C), meeting the hardness requirements of the stamping die;
5) mechanically machining the hardened Bainite die inserts to yield precisely sized die inserts;
6) nitriding the precisely sized die inserts; the precisely sized die inserts are nitrided at a temperature of 520° C.-600° C. using a surface plasma nitriding process, to form a nitriding layer having a thickness of 110-150 and a white bright layer having a thickness of 3-8 μm; the surface plasma nitriding process is performed under the following conditions: voltage: 910-980 V; atmosphere ratio: NH₃:Ar=1:7; furnace pressure: 200-280 Pa; nitriding temperature: 520° C.-600° C.; nitriding time: 5-9 hours; after nitriding treatment, the surface hardness of the die inserts is increased to 820-920 HV_{0.3} (Vickers-hardness); and
7) assembling the die inserts to yield a Bainite hot-working die.

Compared with the prior art, the Bainite die steel of the disclosure can produce secondary strengthening effect by controlled cooling after forging through the design and adjustment of the proportion of the alloy compositions, especially the proportion of carbon and alloy elements. After forging and rough machining, primary tempering is carried out, so that the secondary strengthening effect occurs in the Bainite die steel, and the die steel has excellent hardness, wear resistance and toughness, with excellent comprehensive mechanical properties. By utilizing this feature, the annealing softening treatment before mechanical rough machining and the quenching hardening treatment after mechanical rough machining in the existing technology are omitted.

Furthermore, the second tempering treatment process before mechanical precision machining and the surface nitriding process after precision machining are merged into one treatment process. In the treatment process, tempering can improve the toughness of the die inserts and nitriding can improve the surface hardness of the die inserts, thereby saving the number of processes, shortening the preparation process of existing hot-working dies, reducing production cycles and energy consumption.

### Example 1

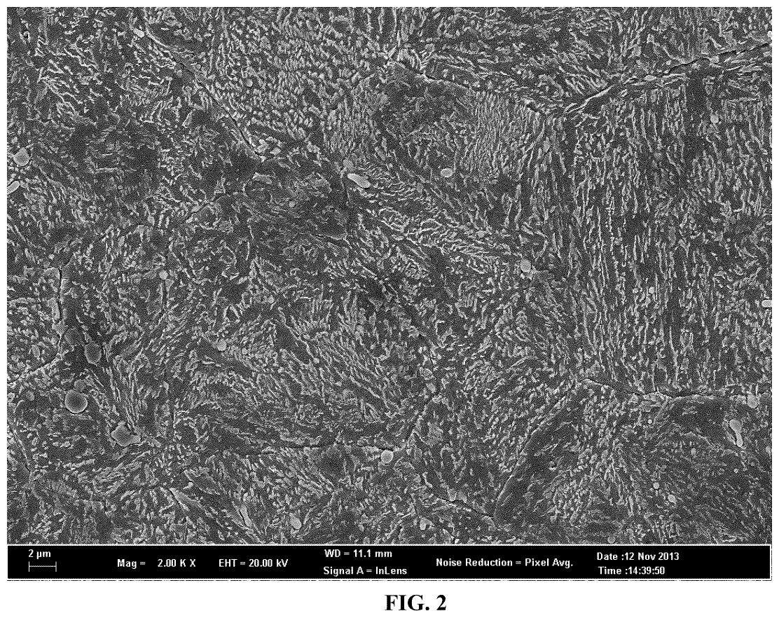

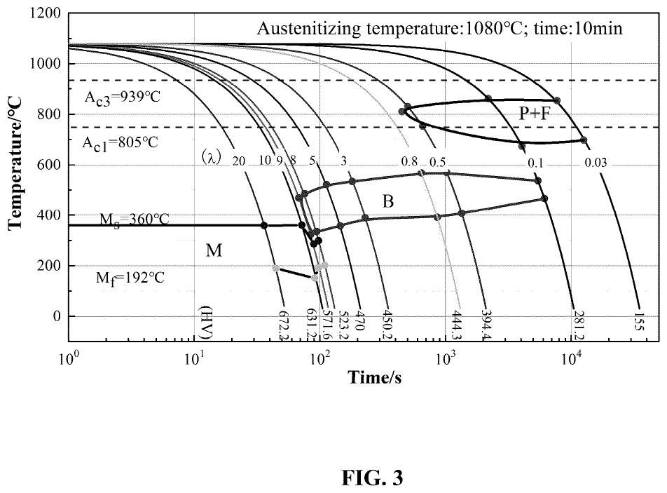

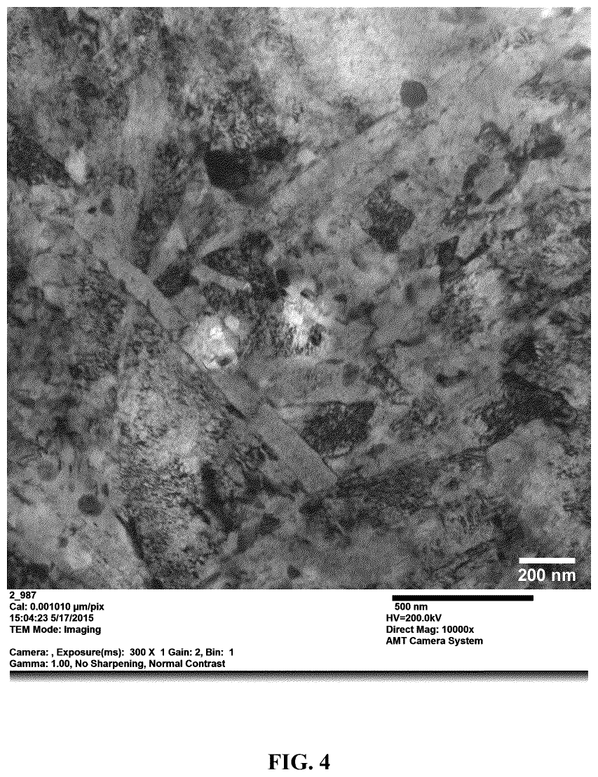

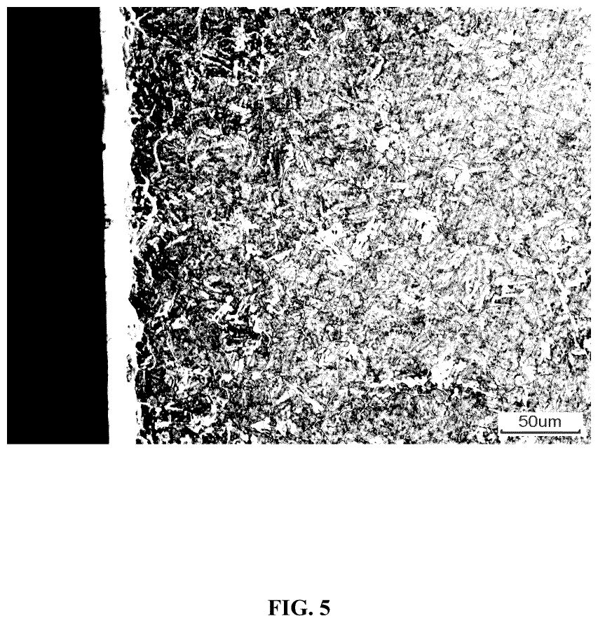

The Bainite hot-working die of the example comprises, by weight, C: 0.50%, Si: 0.20%, Mn: 1.00%, W: 2.10%, Mo: 3.50%, V: 0.50%, Co: 0.60%, RE: 0.01%, P: 0.01%, S: 0.003%, and the balance is Fe and impurities. The method for preparing the Bainite hot-working die is as follows:
1) the alloy raw materials were weighed and mixed according to the above composition proportion, melted in a 1400° C. electric furnace, and cast into steel ingots. The steel ingots were treated through electroslag remelting process, held at 700° C. for 8 hours and annealed, to yield steel billets;
2) the steel billets were heated to a temperature of 1150° C. and held for 8 hours; the steel billets were forged multi-directionally with a final forging temperature of 990° C., and cooled at a rate of 1° C./s to room temperature, to yield the Bainite die billets; after that, the hardness of the Bainite die billets is 405 HV30;
3) the Bainite die billets were mechanically roughened, to yield die inserts; the SEM image of the die steel inserts with full Bainite structure is shown in FIG. 2: the material structure is tempered Bainite structure, in which Bainite carbide is mainly granular. The continuous cooling transformation (CCT) curve of Bainite die steel is shown in FIG. 3, which is a continuous cooling transformation curve of the new die material. When the cooling rate is 0.5-10° C./s, the die material with Bainite as the main structure is obtained;
4) The Bainite die inserts were tempered at 620° C. for 2 h, to yield secondary strengthened Bainite die inserts. The hardness was 49.5 HRC, and the impact toughness value Ak was 118 J, which met the hardness requirements of the stamping die. The transmission electron microscope of the secondary strengthened Bainite die inserts is shown in FIG. 4. The tempered material comprises high-density dislocations and fine carbides, so that the material has good properties, such as hardness and wear resistance;
5) the hardened Bainite die inserts were mechanically machined to yield precisely sized die inserts;
6) the precisely sized die inserts were nitrided at a temperature of 600° C. using a surface plasma nitriding process, to form a nitriding layer having a thickness of 118 and a white bright layer having a thickness of 5 μm; the surface plasma nitriding process was performed under the following conditions: voltage: 920 V; atmosphere ratio: NH₃:Ar=1:7; furnace pressure: 240 Pa; nitriding time: 5 hours; after nitriding treatment, the surface hardness of the die inserts is increased to 890 HV_{0.3}; FIG. 5 shows the metallographic diagram of the material structure of the die inserts of the example after surface plasma nitriding treatment. From the figure, it can be seen that after nitriding treatment, the surface layer of the material is covered by a continuous and uniformly thick compound layer. The hardness of the compound layer can reach around 900 HV_{0.3}, which can effectively resist high-temperature adhesive wear. The sub-surface layer is a diffusion layer with a depth of 120 and comprises Fe₃N, Fe₄N and other compounds and tempered Bainite structure. The hardness of the subsurface layer decreases from the surface to the interior layer, which can provide effective support for the surface layer and improve the high-temperature resistance.
7) the die inserts were assembled to yield a Bainite hot-working die, which is particularly suitable for hot stamping.

### Example 2

The Bainite hot-working die of the example comprises, by weight, C: 0.55%; Si: 0.22%; Mn: 1.30%; W: 2.50%; Mo: 4.50%; V: 0.80%; Co: 0.90%; RE: 0.05%, P: 0.01%, S: 0.01%, and the balance is Fe and impurities. The method for preparing the Bainite hot-working die is as follows:
1) the alloy raw materials were weighed and mixed according to the above composition proportion, melted in a 1400° C. electric furnace, and cast into steel ingots. The steel ingots were treated through electroslag remelting process, held at 700° C. for 8 hours and annealed, to yield steel billets;
2) the steel billets were heated to a temperature of 1150° C. and held for 8 hours; the steel billets were forged multi-directionally with a final forging temperature of 1010° C., and cooled at a rate of 2° C./s to room temperature, to yield the Bainite die billets; after that, the hardness of the Bainite die billets is 425 HV30;
3) the Bainite die billets were mechanically roughened, to yield die inserts;
4) The Bainite die inserts were tempered at 580° C. for 2 h, to yield secondary strengthened Bainite die inserts. The hardness was 50.5 HRC, and the impact toughness value Ak was 106 J, which met the hardness requirements of the stamping die;
5) the hardened Bainite die inserts were mechanically machined to yield precisely sized die inserts;
6) the precisely sized die inserts were nitrided at a temperature of 560° C. using a surface plasma nitriding process, to form a nitriding layer having a thickness of 136 and a white bright layer having a thickness of 4.85 μm; the surface plasma nitriding process was performed under the following conditions: voltage: 950 V; atmosphere ratio: NH₃:Ar=1:7; furnace pressure: 260 Pa; nitriding time: 6 hours; after nitriding treatment, the surface hardness of the die inserts is increased to 910 HV_{0.3};
7) the die inserts were assembled to yield a Bainite hot-working die, which is particularly suitable for hot stamping.

### Example 3

The Bainite hot-working die of the example comprises, by weight, C: 0.60%; Si: 0.20%; Mn: 1.50%; W: 3.00%; Mo: 5.0%; V: 1.00%; Co: 1.10%; RE: 0.07%, P: 0.01%, S: 0.02%, and the balance is Fe and impurities. The method for preparing the Bainite hot-working die is as follows:
1) the alloy raw materials were weighed and mixed according to the above composition proportion, melted in a 1400° C. electric furnace, and cast into steel ingots. The steel ingots were treated through electroslag remelting process, held at 700° C. for 8 hours and annealed, to yield steel billets;
2) the steel billets were heated to a temperature of 1050° C. and held for 8 hours; the steel billets were forged multi-directionally with a final forging temperature of 1000° C., and cooled at a rate of 2.5° C./s to room temperature, to yield the Bainite die billets; after that, the hardness of the Bainite die billets is 436 HV30;
3) the Bainite die billets were mechanically roughened, to yield die inserts;
4) The Bainite die inserts were tempered at 540° C. for 3.5 h, to yield secondary strengthened Bainite die inserts. The hardness was 51 HRC, and the impact toughness value Ak was 123 J, which met the hardness requirements of the stamping die;
5) the hardened Bainite die inserts were mechanically machined to yield precisely sized die inserts;
6) the precisely sized die inserts were nitrided at a temperature of 520° C. using a surface plasma nitriding process, to form a nitriding layer having a thickness of 133 μm, and a white bright layer having a thickness of 5.2 μm; the surface plasma nitriding process was performed under the following conditions: voltage: 980 V; atmosphere ratio: NH₃:Ar=1:7; furnace pressure: 280 Pa; nitriding time: 7 hours; after nitriding treatment, the surface hardness of the die inserts is increased to 928 HV_{0.3};
7) the die inserts were assembled to yield a Bainite hot-working die, which is particularly suitable for hot stamping.

### Comparison Example 1

The Bainite hot-working die of the example comprises, by weight, C: 0.50%; Si: 0.20%; Mn: 1.00%; W: 2.10%; Mo: 3.50%; V: 0.50%; Co: 0.60%; RE: 0.01%, P: 0.01%, S: 0.003%, and the balance is Fe and impurities.

The preparation method of the hot-working die followed the long process shown in FIG. 6, and the hot-working die was nitrided according to the same surface nitriding conditions as in Example 1. After nitriding, the performance of the die insert is as follows: the hardness of the core material was 49.3 HRC, the impact toughness value Ak was 115 J, the thickness of the nitriding layer was 118 μm, and the thickness of the white bright layer on the surface of the die was 5 μm. After nitriding treatment, the surface hardness of the die insert was increased to 870 HV_{0.3}.

Comparing Example 1 with Comparison example 1, it can be seen that the technical solution of the disclosure omits annealing and softening after forging, high-temperature quenching and hardening, and secondary tempering treatment. The performance of the die insert material is equivalent to that obtained through the long process treatment, and even slightly better in terms of core hardness. By omitting the aforementioned processes, the preparation cycle of the hot-working dies can be reduced, saving the energy consumption and production costs.

### Comparison Example 2

The Bainite hot-working die of the example comprises, by weight, C: 0.40%; Si: 0.90%; Mn: 0.50%; Cr: 4.60%; Mo: 1.20%; V: 0.80%; RE: 0.01%, P: 0.01%, S: 0.003%. The Bainite hot-working die is prepared using the same method as Example 1, and the performance of the die insert obtained after nitriding is: the hardness of the center was 45.2 HRC, the impact toughness value Ak was 105 J, and the thickness of the nitriding layer was 118 μm, and the thickness of the white bright layer on the surface of the die is 3 μm. After nitriding treatment, the surface hardness of the die insert was increased to 790 HV_{0.3}.

Comparing Example 1 with Comparison example 2, it can be seen that after changing the alloy composition of the die steel, if the die insert is still prepared according to the preparation process of Example 1 of the disclosure, the technical effect of Example 1 cannot be achieved (Example 1 has a core hardness of 50.5 HRC, an impact toughness value Ak of 106 J, and a surface hardness of 910 HV_{0.3}). This indicates that the unique alloy composition of die steel of the disclosure provides a prerequisite for saving process steps.

In addition, comparing the performance of the hot-working die prepared in embodiments 1-3 of the disclosure with the existing austenitic hot stamping die, it can be seen that the die produced by the disclosure has comparable comprehensive mechanical properties with the existing austenitic hot stamping die. It can be seen that the new Bainite die material of the disclosure can obtain comprehensive properties similar to the traditional preparation process after being processed by the short process preparation process, and it has obvious advantages in preparation time and manufacturing cost.

The example used It will be obvious to those skilled in the art that changes and modifications may be made, and therefore, the aim in the appended claims is to cover all such changes and modifications.

What is claimed is:

1. A method for preparing a Bainite hot-working die, the method comprising:
1) weighing and mixing alloy raw materials comprising: C: 0.50-0.60%, Si: 0.20-0.25%, Mn: 1.00-1.50%, W: 2.10-3.00%, Mo: 3.50-5.00%, V: 0.50-1.00%, Co: 0.60-1.10%, P≤0.02%, rare earth (RE): 0.01-0.10%, (RE)/(S)>3.0, (RE)×(S)<0.004%, the balance being Fe and impurities; smelting, casting, annealing the alloy raw materials, to yield steel billets;
2) forging the steel billets to obtain Bainite die billets;
3) mechanically roughening the Bainite die billets, to yield die inserts;
4) tempering the die inserts, to yield hardened Bainite die inserts through secondary strengthening of Bainite;
5) mechanically machining the hardened Bainite die inserts to yield precisely sized die inserts;
6) nitriding the precisely sized die inserts; and
7) assembling the die inserts to yield a Bainite hot-working die.

2. The method of claim 1, wherein in 2), the steel billets are heated to a temperature of 1050° C.-1150° C. and held for 6-10 hours; the steel billets are forged multi-directionally with a final forging temperature ≥980° C., and cooled at a rate of 0.5-3° C./s, to yield the Bainite die billets.

3. The method of claim 1, wherein in 4), the die inserts are tempered at a temperature of 540° C.-680° C. for 2-3 times, and each tempering time lasts 2.0-6.0 hours, to produce secondary strengthening effect on the die inserts.

4. The method of claim 1, wherein in 6), the precisely sized die inserts are nitrided at a temperature of 520° C.-600° C., to form a nitriding layer having a thickness of 110-150 μm, and a white bright layer having a thickness of 3-8 μm.

5. The method of claim 1, wherein in 6), nitriding adopts a surface plasma nitriding process.

6. The method of claim 5, wherein in 6), the surface plasma nitriding process is performed under the following conditions: voltage: 910-980 V; atmosphere ratio: NH₃:Ar=1:7; furnace pressure: 200-280 Pa; nitriding temperature: 520° C.-600° C.; nitriding time: 5-9 hours.
